(19) United States
(12) Patent Application Publication
(10) Pub. No.: US 2024/0412031 A1
(43) Pub. Date: Dec. 12, 2024

(54) Machine Learning Systems And Methods For Artificial Intelligence Prompt Optimization

(71) Applicant: Drew Rayman, New York, NY (US)

(72) Inventor: Drew Rayman, New York, NY (US)

(21) Appl. No.: 18/736,344

(22) Filed: Jun. 6, 2024

Related U.S. Application Data
(60) Provisional application No. 63/471,357, filed on Jun. 6, 2023.

(51) Int. Cl. G06N 3/006

(52) U.S. Cl. CPC G06N 3/006

(57) ABSTRACT

Machine learning systems and methods for artificial intelligence prompt optimization are provided. The system presents a customized user interface that allows the user to specify information relating to a user's role, and processes this information along with industry-specific information/context and company-specific information in order to generate optimized prompts for usage by an artificial intelligence platform in order to optimize the accuracy and usefulness of information generated by such platforms. The system receives an original prompt from a user and alters the original prompt by adding one or more optimization components to the prompt to generate an optimized prompt. The optimized prompt is then transmitted to a platform for processing thereby, and the results are returned to the user.

### RELATED APPLICATIONS

The present application claims the priority of U.S. Provisional Application Ser. No. 63/471,357 filed on Jun. 6, 2023, the entire disclosure of which is expressly incorporated herein by reference.

### BACKGROUND

### Technical Field

The present disclosure relates generally to the field of machine learning. More specifically, the present disclosure relates to machine learning systems and methods for artificial intelligence prompt optimization for business.

### RELATED ART

Artificial Intelligence (“AI”) systems such as ChatGPT, Bing Chat, Bard, etc., are generative AI systems which generate content in response to one or more queries or “prompts” posed to such systems by users. For example, a user might desire to have a paragraph of text written about the history of the Civil War, and can request that a chatbot platform do so by inputting a prompt to the platform along the lines of “Write a one-page brief overview of the history of the U.S. Civil War” whereupon the platform executes various AI algorithms which generate the requested text in response.

While the capabilities of generative AI are certainly impressive, current chatbot platforms are not perfect, and often generate results that are inaccurate or not useful. Specifically, current chatbot and artificial intelligence platforms do not adequately take into account information about the user (such as a business persona, role, job title, job responsibility, etc.) when prompts are formulated, nor do they take into account other types of information such as industry-specific information and context related to the user's role, as well as proprietary company-specific information related to the specific company at which a user is employed. Such information can be employed to optimize the results generated by existing chatbot platforms, but is unfortunately severely underutilized. Moreover, existing chatbot platforms do not allow users to alter, in real time, the foregoing types of information, nor do they allow the user dynamically adjust individual traits such as the degree to which a user is logical versus fanciful, the degree to which the user is realistic versus imaginative, and the degree to which the user's thinking is linear versus non-linear, among other traits, nor do existing chatbot platforms take such individual trait information into account when formulating results for the user.

Accordingly, what would be desirable are machine learning systems and methods for chatbot prompt optimization which address the foregoing and other needs.

### SUMMARY

The present disclosure relates to machine learning systems and methods for artificial intelligence prompt optimization. The system presents a customized user interface that allows the user to specify information relating to a user's role (including information relating to the user's behavior and personality), and processes this information along with industry-specific information/context and company-specific information in order to generate optimized prompts for usage by one or more artificial intelligence (e.g., chatbot) platforms, in order to optimize the accuracy and usefulness of information generated by such platforms. The system receives a query from a user (the “original prompt”) and then automatically alters the original prompt by adding one or more optimization components to the prompt to generate an optimized prompt. The optimized prompt is then transmitted to a platform for processing thereby, and the results are returned to the user. The user can dynamically adjust the information relating to the user's role (including behavior/personality traits), the industry-specific information/context, and the company-specific information. The system could communicate with one or more corporate computer systems in order to automatically obtain information from a company useful in generating an optimized prompt. The system can also generate one or more artificial intelligence (AI) guiderails for further generating an optimized prompt.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating the system of the present disclosure;

FIGS. 2-5 are flowcharts illustrating processing steps carried out by the system of the present disclosure;

FIGS. 6-18 are screenshots illustrating user interface screens generated by the system of the present disclosure;

FIG. 19 is a diagram illustrating a pre-trained ethics model in accordance with the systems and methods of the present disclosure; and

FIG. 20 is a flowchart illustrating additional processing steps carried out by the system of the present disclosure for generating artificial intelligence (AI) guardrails to improve chatbot prompt generation and results.

### DETAILED DESCRIPTION

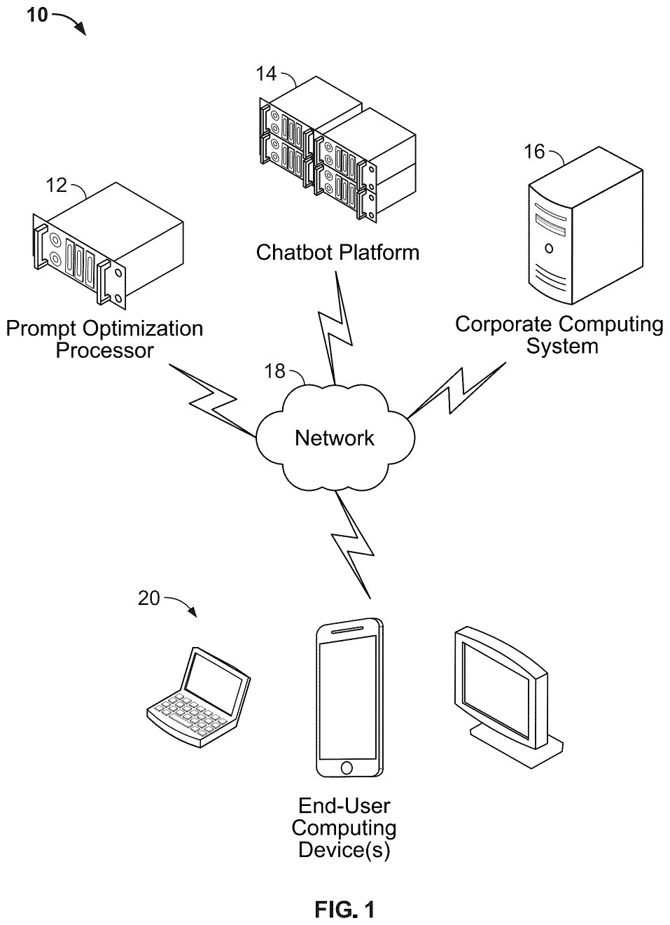

The present disclosure relates to machine learning systems and methods for artificial intelligence prompt optimization, as discussed in detail below in connection with FIGS. 1-20.

FIG. 1 is a diagram illustrating the system of the present disclosure, indicated generally at 10. The system 10 includes an artificial intelligence (e.g., chatbot) prompt optimization processor 12 which is in communication with a chatbot platform 14 or other artificial intelligence platform and is programmed in accordance with the present disclosure and which optimizes one or more chatbot queries prior to submission of the optimized queries to the chatbot platform 14, so as to improve the results generated by the chatbot platform 14. The chatbot platform 14 could be any suitable chatbot platform or artificial intelligence platform including, but not limited to, ChatGPT, Bing Chat, Bard, or other suitable chatbot platform. Additionally, the prompt optimization processor 12 could be in communication with one or more corporate computing systems 16 in order to obtain information about one or more corporate resources (e.g., information about employees, products or services offered by a business, or other information), which information can be utilized by the prompt optimization processor 12 in order to generate an optimized chatbot prompt for submission to the chatbot platform 14. The prompt optimization processor 12, the chatbot platform 14, and the corporate computing system 16 could be in communication over a network 18, which includes, but is not limited to, a local area network (LAN), a wide area network (WAN), the Internet, a wireless network, a cellular data network, a mesh network, or other suitable communications network.

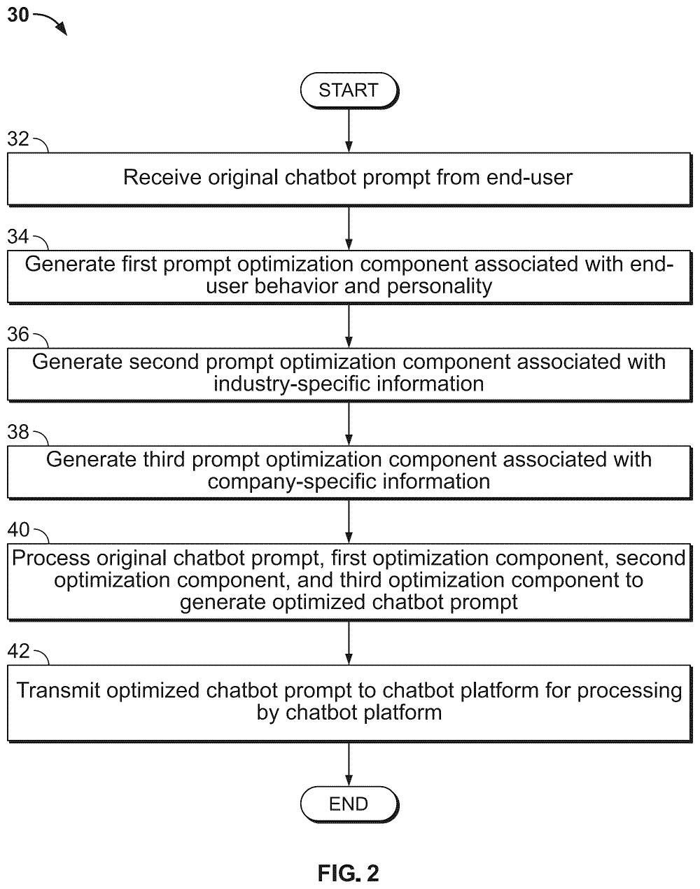

Additionally, a user can interact with the prompt optimization processor 12 using one or more end-user computing devices 20, such as a smart phone, a tablet computer, a laptop computer, a desktop computer, etc., which devices 20 are in communication with the prompt optimization processor 12 via the network 18. The prompt optimization processor could be any suitable computing device/platform such as a server, a cloud computing platform, or other suitable computing device/platform, and could be programmed to carry out the processing steps described in detail below in connection with FIGS. 2-5. Such programming could be in the form of computer-readable instructions stored on a non-transitory, computer-readable medium (e.g., one or more memories of the prompt optimization processor 12) and executed by one or more processors (e.g., one or more microprocessors) of the prompt optimization processor 12.

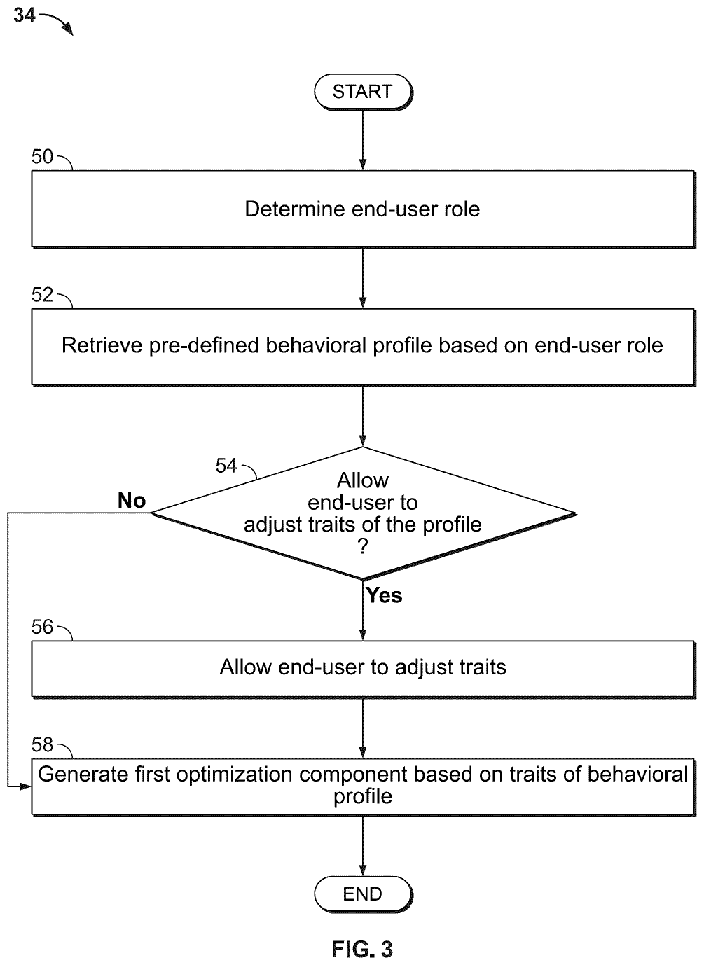

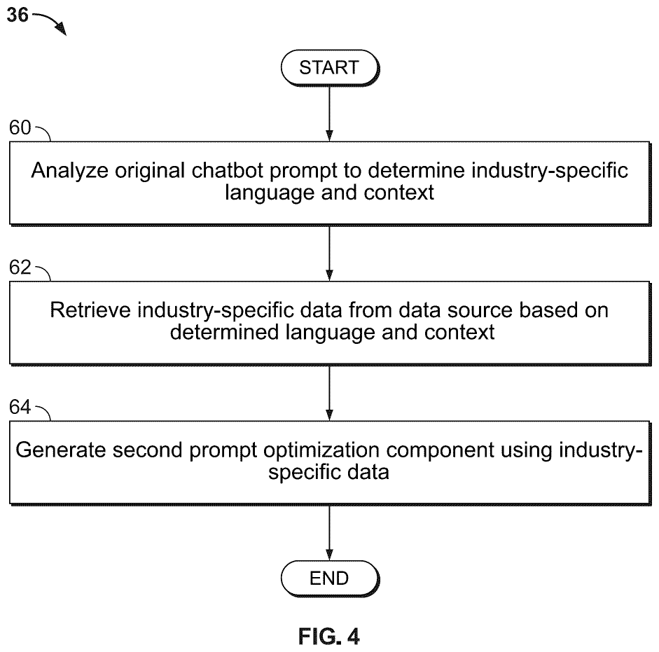

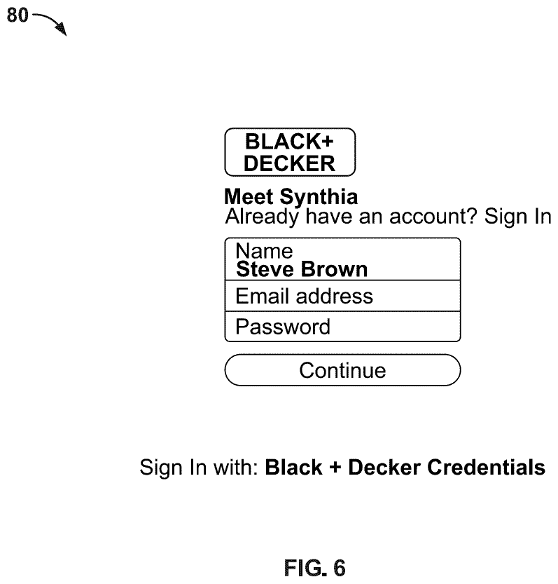

FIG. 2 is a flowchart illustrating processing steps 30 carried out by the system 10 of FIG. 1. Beginning in step 32, the prompt optimization processor 12 receives an original chatbot prompt from an end-user. Such prompt could be entered by the user using the end-user devices 20 and a suitable graphical user interface displayed on the end-user devices 20 and described in greater detail below in connection with FIGS. 6-10. In step 34, the prompt optimization processor 12 generates a first prompt optimization component associated with one or more end-user behaviors or personality traits. Next, in step 36, the prompt optimization processor 12 generates a second prompt optimization component associated with industry-specific information. Then, in step 38, the prompt optimization processor 12 generates a third prompt optimization component associated with company-specific information (which information could be obtained from the corporate computing system 18 of FIG. 1). Each of steps 34-38 are described in greater detail below in connection with FIGS. 3-5.

In step 40, the prompt optimization processor 12 processes the original chatbot prompt, the first optimization component, the second optimization component, and the third optimization component to generate an optimized chatbot prompt. Finally, in step 42, the prompt optimization processor 12 transmits the optimized chatbot prompt to the chatbot platform 14 for processing by the chatbot platform 14, and returns the results to the user via the end-user device 20. By including the first, second, and third optimization components in the optimized chatbot prompt, the system 10 greatly improves the accuracy and relevance of results generated by the chatbot platform 14.

FIG. 3 is a flowchart illustrating processing step 34 of FIG. 2 in greater detail. Beginning in step 50, the system determines a role of an end-user of the system. Such role could be, for example, a job title or other indicator of a job function, and could be ascertained by the system by retrieving information from the corporate computer system 16 of FIG. 1. Next, in step 52, the system retrieves one or more pre-defined behavioral profiles (traits) based on the determined end-user role. For example, if the job title is determined by the system to be “engineer,” then the system could determine that the user's behavioral profile includes traits such as logical, neat, organized, etc. In step 54, a determination is made as to whether to allow the end-user to adjust one or more traits of the profile. If so, step 56 occurs, wherein the system allows the user to adjust the one or more traits. In step 58, the system generates the first optimization component based on the traits of the behavioral profile. By way of example, consider these two different users within the same corporation: Employee 1 is the Creative Director in the Marketing Department, and Employee 2 is Vice President of Finance, in the Finance Department. Employee 1 would welcome a less linear, more creative approach to problem solving, whereas Employee 2 would rely on less linear, more fact-based prompts and answers (these are “traits”). Industry expertise would vary dramatically. Employee 1 needs a broad understanding of industry practices for marketing, consumers, advertising return on investment (ROI), whereas Employee 2 needs compliance and regulatory industry specific knowledge, accounting and procedural practices for the industry, which is of no use to Employee 1 (this is “expertise”). Within the proprietary data held protected, inside the corporation and separated from the public, are vast resources of data employees need. Employee 1 needs customer data, sales data, budgets etc., and Employee 2 needs all the historic and real-time proprietary corporate finance data (this is called “familiarity”).

It is further noted that the systems and methods of the present disclosure could also adjust one or more chatbot parameters (such as temperature, tokens, frequency penalty, presence penalty, “best of” parameter, inject start text, and inject restart text) in order to further optimize the chatbot platform's response (behavior) to the user's role and traits discussed in connection with FIG. 3. For example, once the user's role (e.g., job title) is determined in connection with FIG. 3, such information can be utilized to adjust one or more of the aforementioned chatbot parameters. Still further, one or more GUI sliders (such as the user interface controls discussed herein) could allow the user to change the aforementioned chatbot parameters (such user interface controls allowing control of the chatbot's style (e.g., cautious), length of response (e.g., brief), surprise (e.g., predictable versus surprising), variety (e.g., repetitive versus novel), exploration (e.g., focused versus explorative), and consideration (e.g., quick versus thoughtful), and gradations thereof).

FIG. 4 is a flowchart illustrating processing step 36 of FIG. 2 in greater detail. Beginning in step 60, the system analyzes the original chatbot prompt to determine industry-specific language and context. Then, in step 62, the system retrieves industry-specific data from a data source based on the determined industry-specific language and context. Finally, in step 64, the system generates the second prompt optimization component using the industry-specific language and context. By way of example, industry-specific databases hold the rules, regulations, language, competitor analysis, trend reports, etc. for an entire industry, say insurance, or healthcare. Enhancing a prompt with this information assures a more accurate and useful response. As another example: the insurance industry might be showing a trend for taking less risk on home insurance due to the nature of weather in the region. With access to this broad source of data, the prompt is automatically infused with more details regarding exposure of this type of risk, whereas the employee may not have crafted a prompt compete enough to recognize the issue.

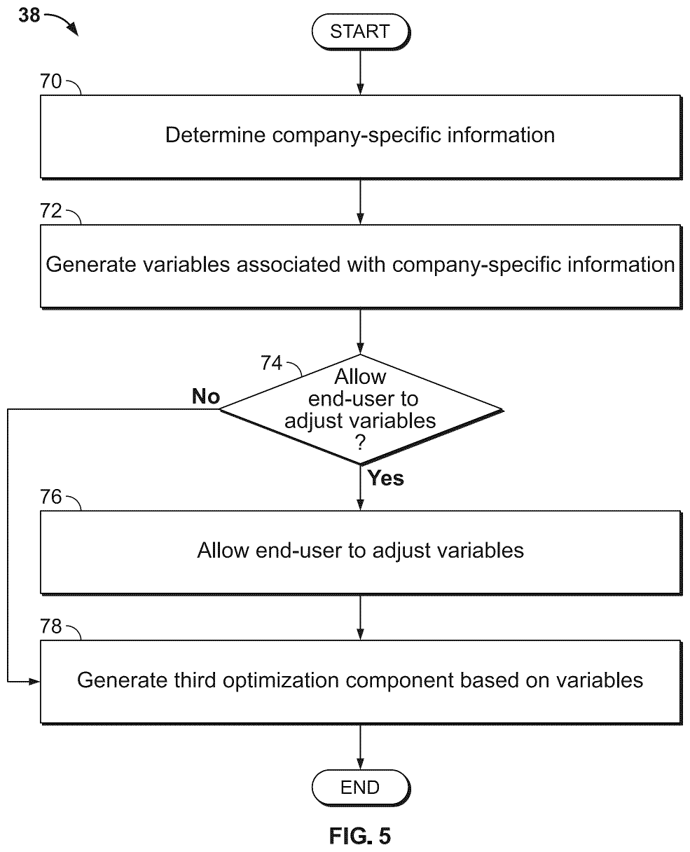

FIG. 5 is a flowchart illustrating step 38 of FIG. 2 in greater detail. Beginning in step 70, the system determines company-specific information. Then, in step 72, the system generates one or more variables associated with the company-specific information. In step 74, a determination is made as to whether to allow the end-user to adjust the one or more variables. If so, step 76 occurs, wherein the end-user is allowed to adjust the one or more variables. In step 78, the system generates the third optimization component based on the one or more variables. Currently, no public AI/chatbot technology has access to proprietary and secured data within a corporation (like finance, salaries, expenditures, customer records, profits, losses, etc.). When this corporate data is available, the understanding of the inner-workings of the company is unprecedented. Asking a question like “why are sales dropping in the Northeast region?” only matters when private chatbot/AI technology is attached to the proprietary data. Without access, the answer is akin to “I don't have access to the required information.” This is called “familiarity.” With access to corporate data, the answer could include changes in competition, pricing, supply, weather, traffic, etc.).

The prompt optimization features of the systems and methods of the present disclosure can be expressed using the following equation:

Original Prompt+Traits+Expertise+Familiarity=Optimized Prompt
where Original Prompt=the original prompt specified by a user, Traits=behavior and personality information, Expertise=industry-specific knowledge, and Familiarity=company-specific knowledge.

FIGS. 6-10 are screenshots illustrating user interface screens generated by the system of the present disclosure. As shown in FIG. 6, the system can generate an initial logon screen 80, wherein the user logs into the system using a user name and password. As can be seen, the login screen 80 as well as subsequent user interface screens could be branded and/or affiliated with a corporate entity having an account with the system of the present disclosure.

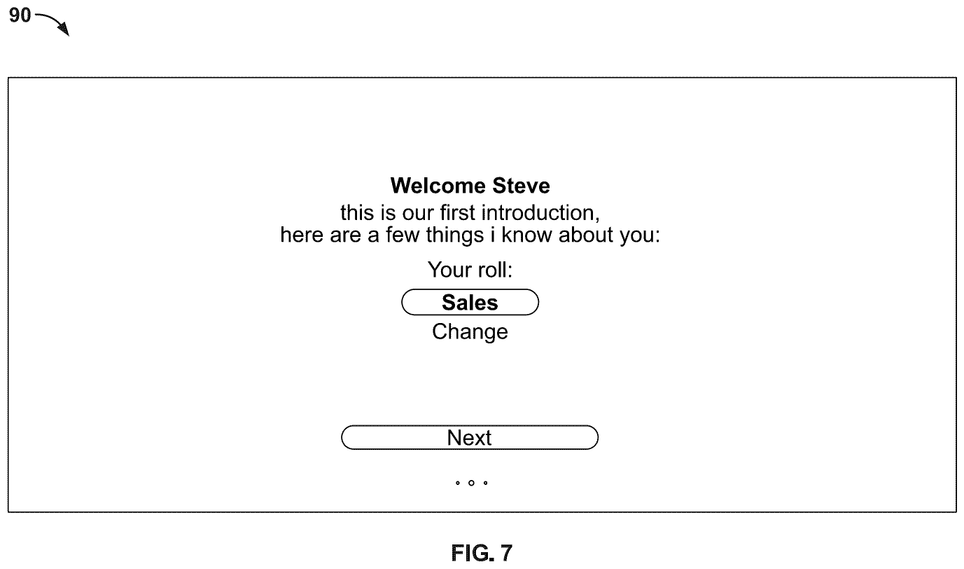

FIG. 7 illustrates a role definition user interface screen 90 generated by the system of the present disclosure. Using the screen 90, the user can define his or her role with an organization, such as sales, marketing, engineering, etc. Any suitable role can be defined/selected by the user using the screen 90.

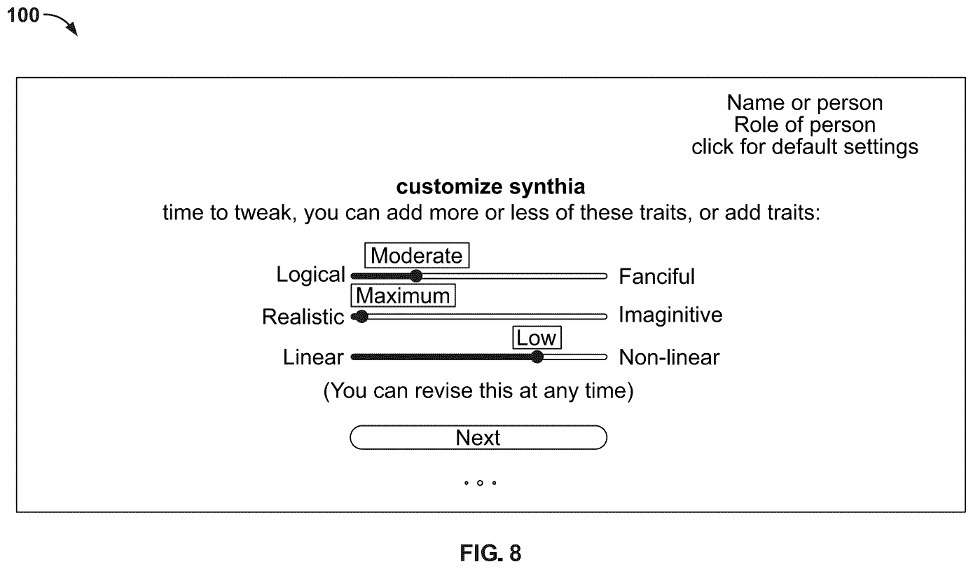

FIG. 8 illustrates a trait customization user interface screen 100 generated by the system of the present disclosure. Using various user interface controls such as sliders and/or buttons (or other suitable user interface controls), the user can adjust one or more traits pertinent to the user, such as the degree to which the user is logical versus fanciful, the degree to which the user is realistic versus imaginative, and the degree to which the user's thinking is linear versus non-linear. Of course, other traits are possible and can be adjusted by the user using the user interface screen 100. Additionally, the user can modify existing or pre-defined traits at any time using the user interface screen 100.

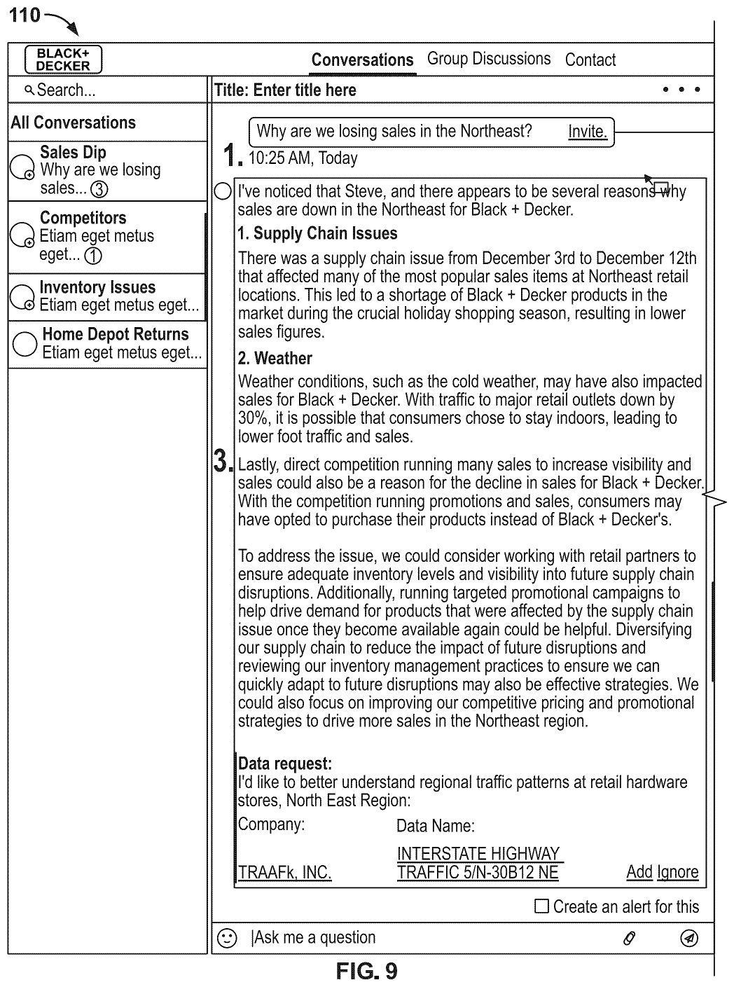

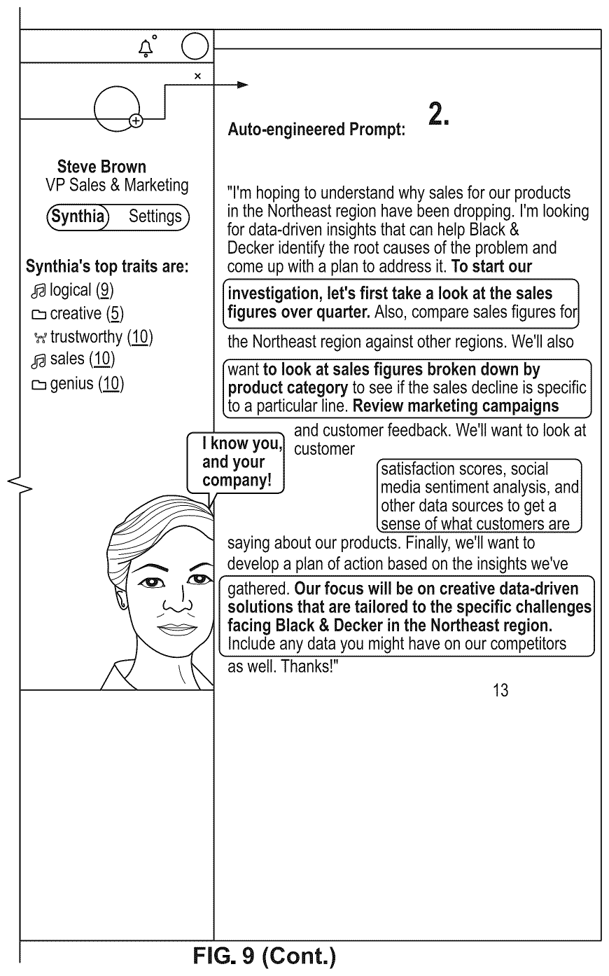

FIG. 9 illustrates a prompt optimization screen 110 generated by the system of the present disclosure. In the screen region “1” of the screen 110, the user can enter a query (“Why are we losing sales in the Northeast?”), which generates an original chatbot prompt (the un-highlighted text shown in screen region “2” of screen 110). The system processes the original chatbot prompt using the processing steps discussed herein in connection with FIGS. 2-5, and generates an optimized chatbot prompt (which includes the original chatbot prompt plus optimized components that are highlighted in the screen region 2 of screen 110). As can be seen, the optimized chatbot prompt includes additional and/or optimized text that includes one or more of the optimization components discussed above in connection with FIGS. 2-5. Specifically, as illustrated in screen region 2, the optimized chatbot prompt includes text relating to sales figures over a quarter, sales figures broken down by product category, review of marketing campaign information, satisfaction scores, media sentiment analysis, a desire to ascertain what customers are saying about products, a desire to focus on creative data-driven solutions tailored to the specific challenges being faced by a particular company in a particular region, and a desire to obtain information about competitors. Importantly, the optimized components (highlighted in screen region 2) are automatically added by the system to the original chatbot prompt based on the role information, industry-specific language/context, and company-specific information automatically obtained by the system as described in connection with FIGS. 2-5. As shown in screen region “3” of the screen 110, the system could optionally provide an explanation as to the various optimization components added to the original chatbot prompt and reasons why such components were added by the system.

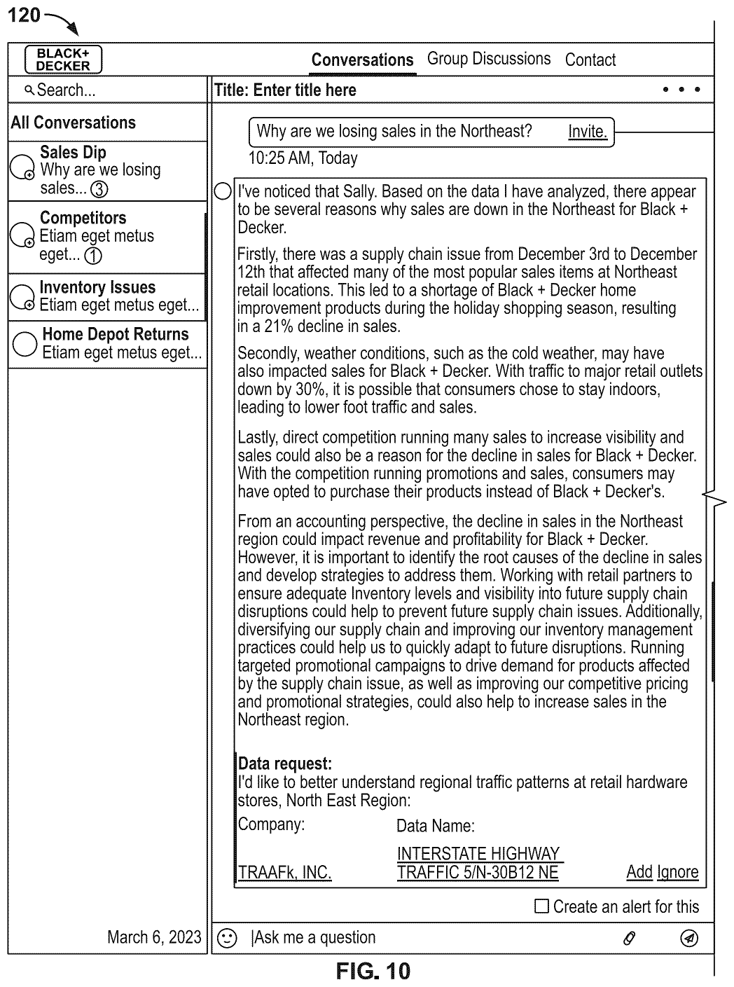

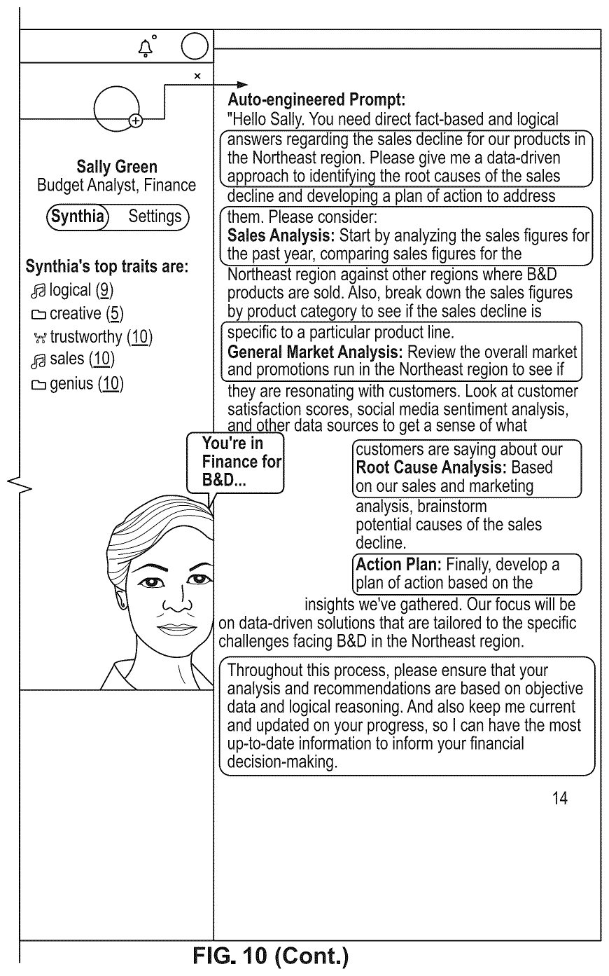

FIG. 10 illustrates another prompt optimization screen 110 generated by the system of the present disclosure. As can be seen, the system can auto-engineers an optimized prompt that is tailored to a specific role of the user in a specific company (here, a person who works in finance at a company in the power tool industry). The optimization components added to the prompt are specifically tailored to the user's role at the company, and are directed to obtaining information useful for that user's role, such as sales analysis information, general market analysis information, root cause analysis, and a request for an action plan. Since the person has been automatically identified by the system as being logical, the optimized chatbot prompt is formatted in a very structured and ordered fashion.

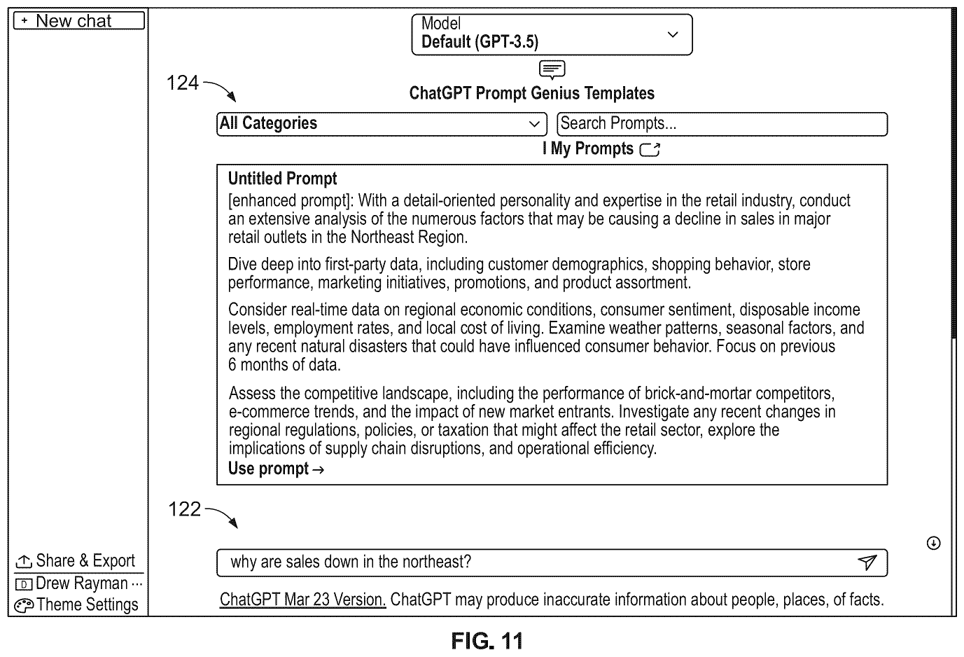

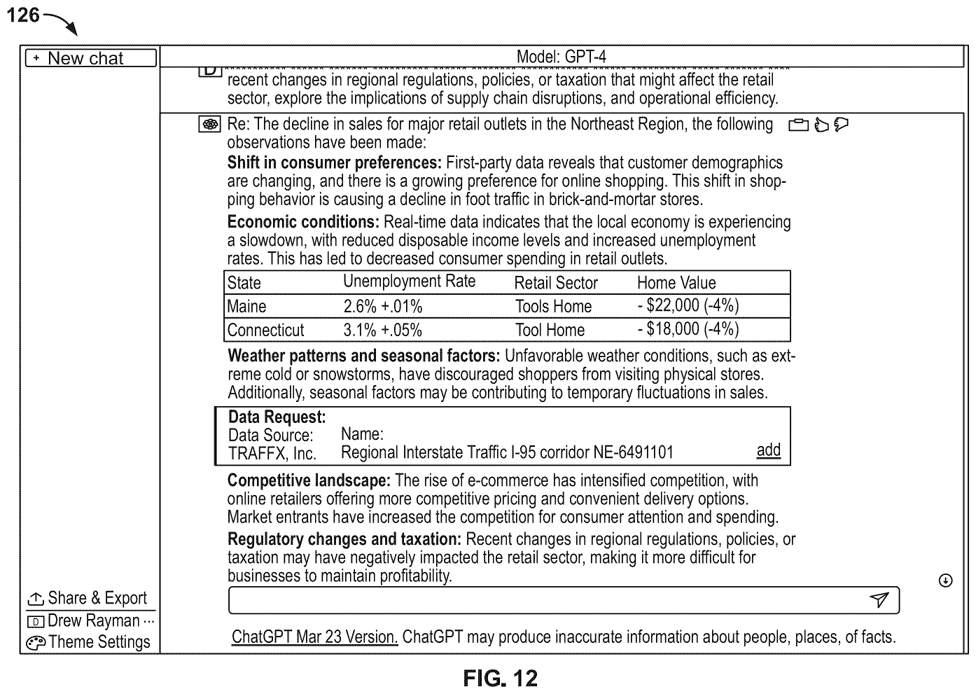

FIG. 11 is a screenshot illustrating another user interface screen generated by the system of the present disclosure. More specifically, this screen provides a simplified interface wherein a user can enter a prompt for a chatbot in the field 122, and the system automatically generates an optimized prompt in the field 124, which is then transmitted to one or more chatbot platforms for processing. As can be seen, the optimized prompt in the field 124 includes the various optimization components discussed herein in accordance with the systems of the present disclosure. Once the chatbot platform has processed the optimized prompt, the results are returned and displayed to the user as shown in the screen 126 of FIG. 12.

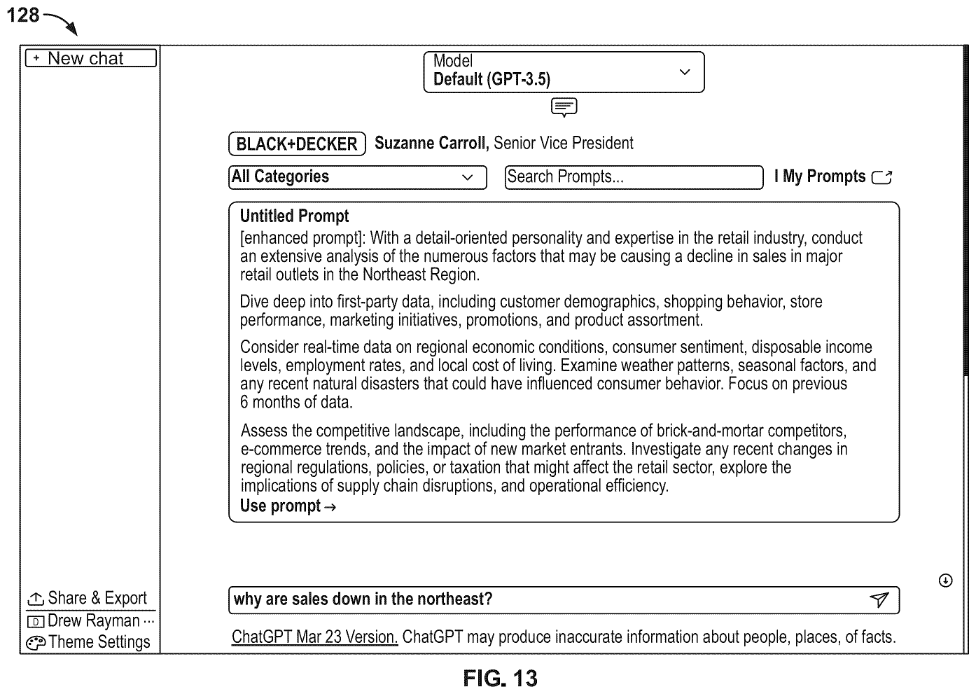

FIG. 13 is a screenshot illustrating another user interface screen 128, wherein the system automatically identifies the name of the user, the user's title, and an employer's identity. Like the screen shown in FIG. 11, the screen 128 allows the user to enter a prompt for a chatbot and an optimized prompt is automatically generated by the system.

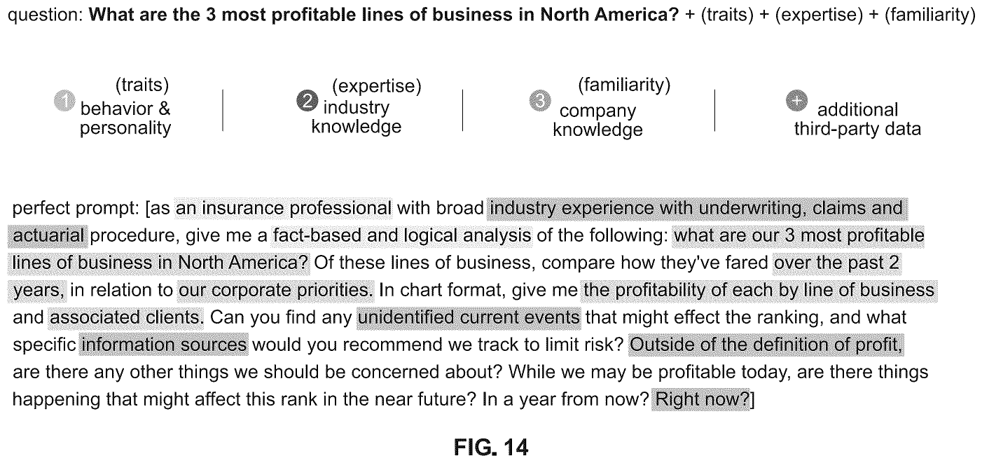

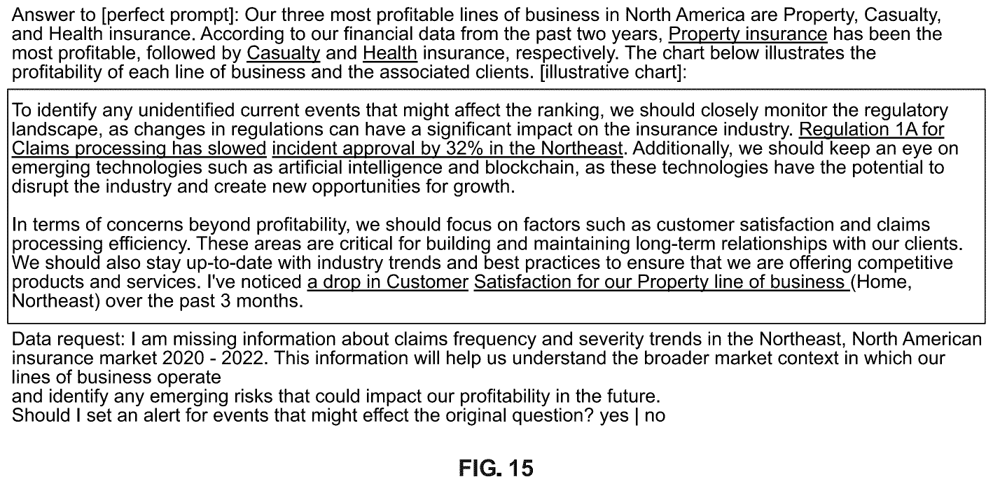

FIG. 14 illustrates generation by the system of an optimized prompt from a prompt input by the user. As can be seen, the system receives the prompt “What are the 3 most profitable lines of business in North America.” The system then generates the optimized prompt (“as an insurance professional with broad industry experience with underwriting, claims and actuarial procedure . . . ”) which includes first optimization components (behavior and personality information highlighted in green), second optimization components (industry knowledge information highlighted in purple), third optimization components (company knowledge information highlighted in blue) and fourth optimization components (additional third-party data highlighted in red). Once the optimized prompt has been generated by the system and sent to a chatbot platform for processing, the results are returned as illustrated in FIG. 15. As can be seen, the result screen in FIG. 15 also queries whether the user would like to set an automatic alert for events that might affect the original chatbot prompt/question.

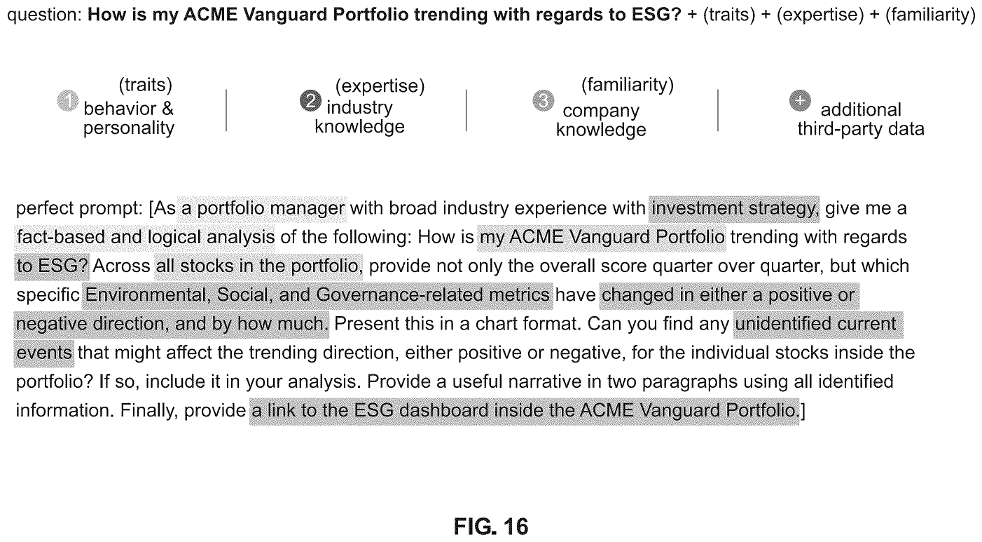

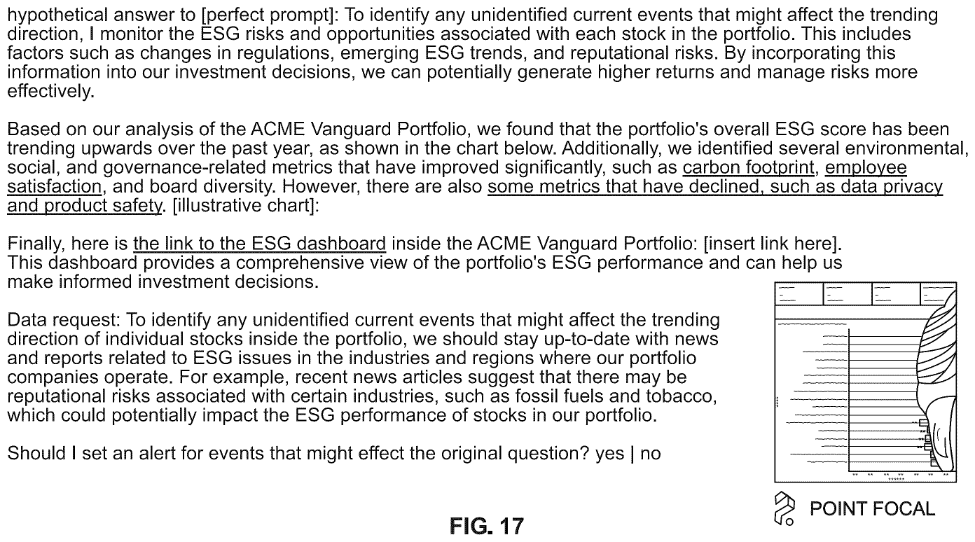

FIG. 16 illustrates generation by the system of another optimized prompt from a prompt input by the user. As can be seen, the system receives the prompt “How is my ACME Vanguard Portfolio trending with regards to ESG?” The system then generates the optimized prompt (“As a portfolio manager with broad industry experience with investment strategy, give me a fact-based and logical analysis of the following: . . . ”) which includes first optimization components (behavior and personality information highlighted in green), second optimization components (industry knowledge information highlighted in purple), third optimization components (company knowledge information highlighted in blue) and fourth optimization components (additional third-party data highlighted in red). Once the optimized prompt has been generated by the system and sent to a chatbot platform for processing, the results are returned as illustrated in FIG. 17. As can be seen, the result screen in FIG. 17 also queries whether the user would like to set an automatic alert for events that might affect the original chatbot prompt/question.

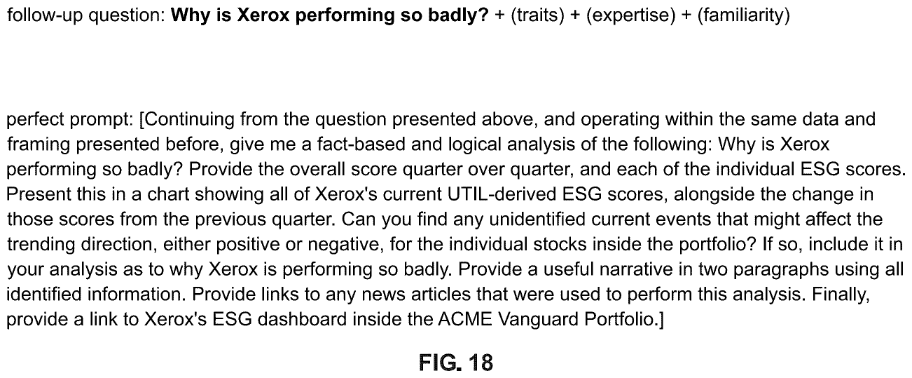

FIG. 18 illustrates another screen generated by the system of the present disclosure. In this screen, the user can ask one or more follow-up questions related to an initial prompt (“Why is Xerox performing so badly?”), which are automatically optimized by the system into the optimized prompt to be transmitted to and processed by a chatbot platform (“Continuing from the question presented above, and operating within the same data and framing presented before, give me a fact-based and logical analysis of the following: . . . ”).

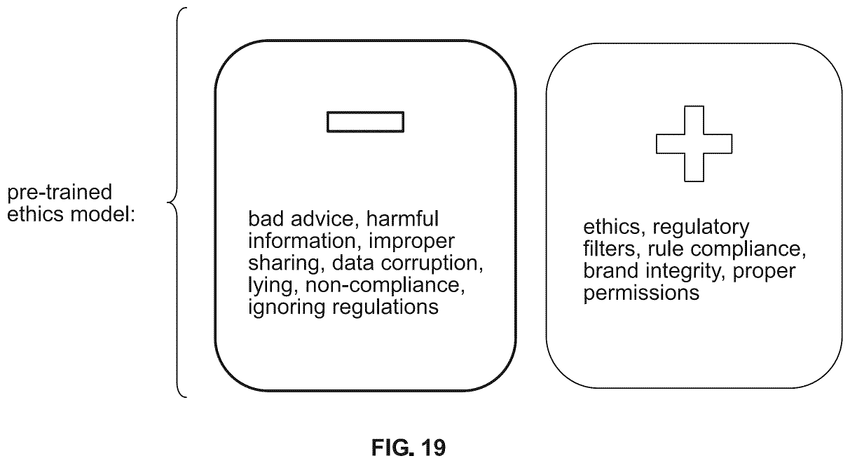

FIG. 19 is a diagram illustrating a pre-trained ethics model in accordance with the system of the present disclosure. As can be seen, the ethics model filters out bad advice, harmful information, improper sharing, data corruption, lying, non-compliance, and ignoring regulations. Additionally, the ethics model incorporates ethics, regulatory filters, rule compliance, brand integrity, and proper permissions.

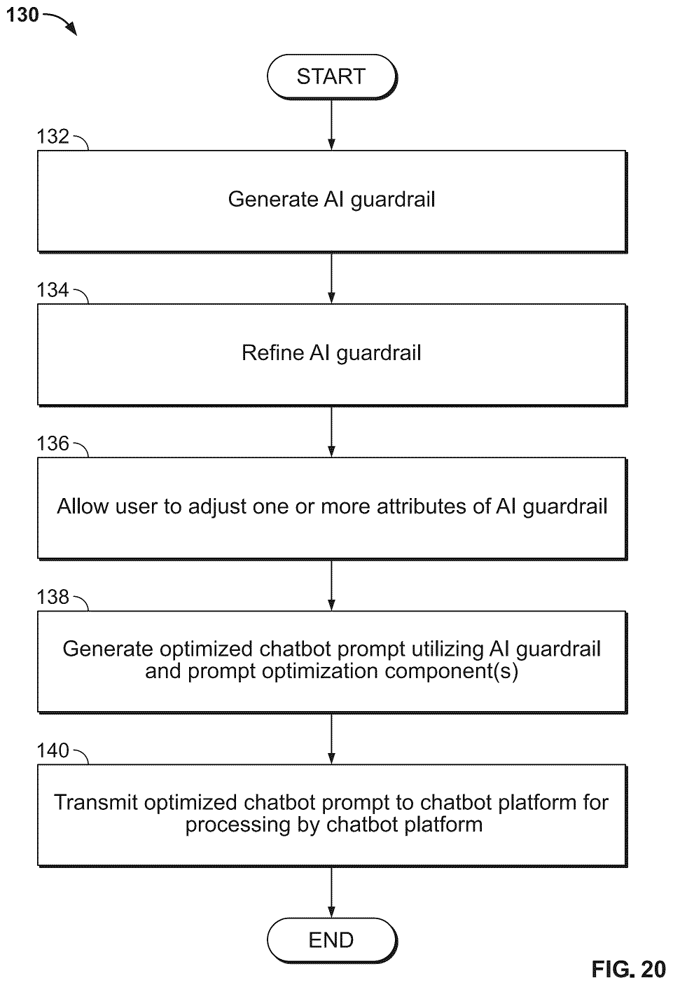

FIG. 20 is a flowchart illustrating additional processing steps, indicated generally at 130, carried out by the system of the present disclosure for generating artificial intelligence (AI) guardrails to improve chatbot prompt generation and results. In step 132, the system generates an AI guardrail, which is an additional set (beyond the prompt optimization components discussed above in connection with FIGS. 1-19) of chatbot prompt optimization attributes that are tailored to a specific topic (such as governance, corporate roles, branding, performance, or other parameters) and which are utilized to improve the accuracy and reliability of output generated by a chatbot platform. The generative AI guardrails could be automatically generated by a large language model (LLM) or other generative AI source, and could include a plurality (e.g., 10-20) parameters that are tailored to a particular topic. Specific examples are provided below. Next, in step 134, the system augments/improves the guardrail by adding clarifying data, which could be provided by a company or third-party. For example, in the case of a governance AI guardrail (e.g., an AI guardrail relating to the topic of corporate governance), the system can optimize such guardrail utilizing corporate compliance documents, manuals, and/or important concerns that are documented somewhere (e.g., in documents, manuals, rules, files, etc.) and which are in digital form (e.g., Microsoft Word document, PDF file, etc.) and/or are easily digitizable from paper records (e.g., using optical character recognition (OCR), computer vision techniques, etc.).

In step 136, the system allows the user (e.g., an employee, an individual, a company, etc.) to adjust one or more attributes of the AI guardrail. For example, the user can add, edit, or delete attributes as necessary/desired, and/or the user can assign ranks to each attribute (e.g., to indicate the importance of each attribute. Companies and/or managers can lock access to one or more guardrail attributes, such that only specific types of employees in specific roles can change attributes. Next, in step 138, the system generates an optimized chatbot prompt using the AI guardrail and one or more prompt optimization components, such as the prompt optimization components discussed above in connection with FIGS. 1-19. Beneficially, the AI guardrail and the one or more prompt optimization components improve accuracy and reliability of chatbot results, which builds user trust, enhances performance, reduces risk, and fosters adoption of chatbot results (accuracy and reliability yields trust, which yields enhanced performance and reduced risk, which yields adoption of chatbot results). Finally, in step 140, the system transmits the optimized chatbot prompt to the chatbot platform, for processing by the platform and generation of results.

Specific, non-limiting examples of the aforementioned AI guardrails are now provided, along with a discussion of their associated attributes.

### Corporate Governance AI Guardrails

These AI guardrails are tailored to ensure that the operations division of a corporation operates within legal and regulatory boundaries, maintaining the corporation's reputation and mitigating risks. The guardrails are as follows:

### 1. Understanding the Regulatory Landscape

a. Government Regulations

Bank Secrecy Act (BSA)/Anti-Money Laundering (AML) Requirements: Ensure proper reporting of suspicious activities and compliance with all AML requirements.

Know Your Customer (KYC) and Customer Due Diligence (CDD): Implement stringent procedures for verifying the identity of clients and understanding the nature of their activities.

Office of Foreign Assets Control (OFAC) Compliance: Adhere to sanctions lists and regulations, preventing transactions with prohibited entities or countries.

Consumer Protection Laws: Comply with regulations aimed at protecting consumers, including the Truth in Lending Act (TILA) and the Fair Credit Reporting Act (FCRA).

Data Protection and Privacy: Adhere to laws such as the General Data Protection Regulation (GDPR) for European clients and local data protection laws, ensuring client data is handled securely and lawfully.

b. Industry Standards and Best Practices

ISO/IEC 27001: Follow the international standard for managing information security.

Payment Card Industry Data Security Standard (PCI DSS): Ensure the secure handling of cardholder information by the operations division.

### 2. Internal Regulations and Policies

a. Operational Integrity and Risk Management

Risk Assessment Procedures: Regularly conduct risk assessments to identify vulnerabilities within client services operations.

Incident Management and Reporting: Establish protocols for promptly addressing and reporting operational failures, breaches, or fraud incidents.

Vendor Management: Ensure that third-party vendors comply with the bank's standards for security and confidentiality.

b. Client Service Excellence

Service Level Agreements (SLAs): Define and adhere to SLAs to maintain high service quality and client satisfaction.

Client Communication Standards: Implement standards for client communications, ensuring clarity, accuracy, and professionalism.

Complaint Management System: Develop a robust system for receiving, investigating, and resolving client complaints in a timely manner.

c. Employee Conduct and Training

Code of Ethics and Conduct: Require all employees within the division to adhere to a strict code of ethics, promoting integrity and accountability.

Ongoing Training: Provide continuous training on compliance matters, operational procedures, and ethical conduct, including specialized training for handling sensitive client information.

d. Audit and Compliance Monitoring

Internal Audits: Conduct regular internal audits to assess compliance with government regulations and internal policies.

Regulatory Compliance Team: Maintain a dedicated team responsible for monitoring regulatory updates and ensuring the division's adherence to new requirements.

### 3. Technology and Security Measures

Cybersecurity Protocols: Implement advanced cybersecurity measures to protect client data and bank operations from cyber threats.

Data Encryption: Use encryption to secure client communications and data storage.

Access Controls: Enforce strict access controls and authentication measures to limit access to sensitive information to authorized personnel only.

### 4. Continuous Improvement and Adaptation

Feedback Mechanisms: Implement mechanisms for collecting feedback from clients and employees to identify areas for improvement.

Regulatory Change Management: Establish a process for swiftly adapting operations in response to regulatory changes.

This AI guardrail is designed to be comprehensive but must be regularly reviewed and updated to respond to evolving regulatory environments and operational challenges. Adhering to these guardrails will help the maintain operational excellence, comply with regulations, and uphold the bank's reputation for integrity and service quality.

### Corporate Performance AI Guardrails

This AI guardrail applies to all Client Services Operations division staff, including client onboarding teams, payment processing units, and client relationship managers. It covers the entirety of client interactions, from initial contact through onboarding, transaction processing, issue resolution, and ongoing service management.

### Core Principles:

Client-Centricity: Always prioritize the client's needs and experience. Tailor services to meet individual client requirements, ensuring personalization and high satisfaction levels.

Regulatory Compliance and Risk Management: Adhere strictly to all relevant laws, regulations, and internal policies. Proactively manage risks associated with client onboarding, transactions, and data security.

Operational Efficiency: Streamline processes through automation, standardized procedures, and continuous process improvement. Aim for zero errors in transaction processing and swift resolution of failed payments.

Communication and Transparency: Maintain clear, timely, and accurate communication with clients and internal teams. Ensure transparency in all operations, including problem-solving steps and resolution timelines.

Performance Monitoring and Feedback: Implement a comprehensive system for monitoring performance metrics related to client onboarding times, payment processing accuracy, issue resolution efficiency, and client satisfaction. Use this data to provide constructive feedback and inform operational improvements.

### Key Performance Indicators (KPIs):

Client Onboarding Time: Reduce the average time taken for new client onboarding, aiming for efficiency without compromising on thoroughness or compliance.

Transaction Error Rate: Maintain a transaction error rate below 0.05%, emphasizing accuracy in payment processing and other financial transactions.

Issue Resolution Time: Aim to resolve at least 95% of client issues, including failed payments, within one business day.

Client Satisfaction Score (CSS): Achieve and maintain a client satisfaction score above 90% through regular surveys and feedback mechanisms.

Regulatory Compliance Rate: Ensure 100% compliance with all regulatory requirements, with no breaches or violations.

Employee Training Compliance: Achieve 100% completion rates for mandatory training sessions among team members, focusing on regulatory, operational, and client service updates.

### Implementation Guidelines:

Conduct quarterly reviews of operational processes and client feedback to identify areas for improvement.

Regularly update the risk management framework to address emerging threats and ensure robust client data protection.

Foster a collaborative environment that encourages innovation, feedback, and shared responsibility for client service excellence.

Utilize technology and data analytics to anticipate client needs, optimize operations, and personalize client interactions.

By adhering to these performance guardrails, the Client Services Operations division will not only meet but exceed expectations, delivering unparalleled service quality and efficiency. This commitment to excellence and continuous improvement will strengthen client trust, loyalty, and satisfaction, driving an organization's (e.g., a bank's) long-term success.

### Corporate Role AI Guiderails

Objective: To provide exceptional customer service to a corporation's clients by addressing inquiries, solving problems, and facilitating transactions within the framework of corporate (e.g., bank) policies and regulatory requirements.

### Key Responsibilities:

### Client Interaction:

Serve as the first point of contact for client inquiries via phone, email, or in-person.

Understand and assess client needs, providing clear, accurate, and timely responses.

Escalate complex issues to the appropriate department or senior staff as needed.

### Transaction Management:

Process client transactions, including account openings, transfers, and closings, ensuring accuracy and compliance with all bank policies and regulatory standards.

Maintain up-to-date knowledge of the bank's products and services to recommend solutions that meet clients' needs.

### Problem Resolution:

Quickly identify and address client issues, providing solutions or alternatives to ensure client satisfaction.

Record and track client complaints or issues, following through to resolution.

### Compliance and Risk Management:

Adhere to all regulatory requirements and bank policies related to client services and transactions.

Participate in regular training on compliance, risk management, and data protection.

### Team Collaboration and Support:

Collaborate with other departments and teams to ensure a seamless client experience.

Support departmental objectives and initiatives, contributing to the improvement of client services processes and practices.

### Skills and Qualifications:

Excellent communication and interpersonal skills.

Strong problem-solving abilities and attention to detail.

Knowledge of banking products, services, and regulatory standards.

Ability to work in a fast-paced environment and manage multiple tasks simultaneously.

Experience in a customer service role within a banking or financial services environment preferred.

### Performance Goals:

Achieve high client satisfaction ratings.

Maintain compliance with all regulatory and internal policy requirements.

Demonstrate efficient and accurate handling of client transactions.

Contribute to the department's objectives by identifying areas for process improvement. (see performance guardrail).

### Safety/Security:

Do not disclose confidential client information without proper authorization and verification.

Avoid providing financial advice unless certified or explicitly authorized by the bank.

Do not process transactions that appear suspicious or violate anti-money laundering (AML) policies; instead, report them to the compliance department immediately.

Stay within the scope of your role when resolving client issues; seek assistance from or escalate to specialists when necessary.

Adhere strictly to the bank's operational procedures and compliance guidelines to minimize risk and ensure the integrity of client transactions.

This AI guardrail is designed to clarify the role's boundaries and expectations, ensuring that Client Services Specialists are well-equipped to support the corporation's (e.g., bank's) clients while maintaining the highest standards of compliance and operational excellence.

### Branding AI Guiderails

This AI guardrail includes 17+ attributes, and provides insights into branding positioning, essence, and strategy. Below is a structured breakdown of the associated attributes

### Brand Heritage Attribute Example:

This attribute reflects an entity's commitment to community, reliability, and innovation.

### Brand Mission Attribute Example:

An example of this attribute aims to capture an entity's services that enhance the financial well-being of individuals, families, and businesses.

### Brand Vision Attribute Example:

To be the most preferred financial partner for its customers, offering innovative solutions that address the evolving financial landscape.

### Brand Values Attribute Example:

Integrity, responsibility, and customer-centricity define an entity. These values are reflected in its commitment to ethical banking, responsible lending, and putting the customer's needs at the forefront.

### Brand Essence Attribute Example:

The core of an entity is rooted in empowerment and trust. It aims to empower consumers and businesses by providing financial stability and insight, reinforcing trust through every interaction.

### Brand Promise Attribute Example:

An entity's pledge to offer personalized, insightful financial solutions that meet the unique needs of its customers, ensuring financial security and growth.

### Target Audience Attribute Example:

The entity targets a broad spectrum of customers, including individuals seeking personal banking solutions, small to medium-sized businesses in need of financial services, and corporations looking for robust financial management.

### Brand Personality Attribute Example:

The entity is seen as approachable, reliable, and forward-thinking. It balances traditional values with a modern outlook, making financial management accessible and understandable.

### Consumer Insight Attribute Example:

Customers seek a banking partner that not only understands their financial goals but also provides the tools and advice to achieve them. They value transparency, case of use, and personalized service.

### Competitive Set Attribute Example:

The entity competes with other national and regional banks, credit unions, and emerging financial technology (fintech) companies. Key competitors include Bank A, Bank B, Bank C, and innovative online banking platforms.

### Reasons to Believe Attribute Example:

The entity's long history, comprehensive range of products and services, personalized customer experiences, and commitment to innovation and security serve as compelling reasons to trust and choose the bank.

### Brand Archetype Attribute Example:

As a “Caregiver,” the entity focuses on nurturing and protecting its customers' financial health, striving to provide stability and support.

### Brand Challenges Attribute Example:

Navigating the digital transformation in banking, staying competitive with fintech innovations, and maintaining customer trust in a landscape of increasing cybersecurity threats are ongoing challenges.

### Brand Tone Attribute Example:

The brand communicates with clarity, confidence, and warmth. Its messaging is designed to be engaging, informative, and reassuring.

### Key Visuals Attribute Example:

Visuals often highlight the human aspect of banking, showcasing diverse individuals and businesses thriving with the support of the entity. The imagery reinforces accessibility and community engagement.

### Customer Experience (CX) Attribute Example:

The entity aims to deliver a seamless, intuitive banking experience across all touchpoints, including online banking, mobile apps, and in-person services at branches.

### Brand Touchpoints Attribute Example:

These include its website, mobile apps, social media channels, advertising campaigns, community events, and physical branches. Each touchpoint is an opportunity to reinforce the brand's values, promise, and essence.

By thoroughly examining these attributes, this AI guardrail gains a holistic understanding of the entity's brand strategy, identity, and the way it resonates with its customers and distinguishes itself in the competitive banking landscape.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

What is claimed is:

1. A machine learning system for artificial intelligence prompt optimization, comprising:
a prompt optimization processor in communication with a chatbot platform and an end-user computing device, the prompt optimization processor programmed to:
receive an original chatbot prompt from the end-user computing device;
generate at least one prompt optimization component;
process the original chatbot prompt and the at least one prompt optimization component to generate an optimized chatbot prompt; and
transmit the optimized chatbot prompt to the chatbot platform for processing by the chatbot platform.

2. The system of claim 1, wherein the at least one prompt optimization component comprises a first prompt optimization component associated with an end-user behavior and personality.

3. The system of claim 2, wherein the processor retrieves a pre-defined behavioral profile based on an end-user role, and generates the first optimization component based on one or more traits of the behavioral profile.

4. The system of claim 3, wherein the processor allows the end-user to adjust the one or more traits of the behavioral profile.

5. The system of claim 2, wherein the at least one prompt optimization component comprises a second prompt optimization component associated with information relating to an industry.

6. The system of claim 5, wherein the processor analyzes the original chatbot prompt to determine at least one of industry-specific language and context.

7. The system of claim 6, wherein the processor retrieves industry-specific data from a data source based on the industry-specific language or context.

8. The system of claim 7, wherein the processor generates the second prompt optimization component using the industry-specific data.

9. The system of claim 5, wherein the at least one prompt optimization component comprises a third prompt optimization component associated with information relating to a company.

10. The system of claim 9, wherein the processor generates a plurality of variables in response to the information relating to the company, and generates the third prompt optimization component based on the plurality of variables.

11. The system of claim 10, wherein the processor allows an end-user to adjust one or more of the plurality of variables.

12. The system of claim 1, wherein the processor generates one or more artificial intelligence guardrails and processes the at least one optimization component and the one or more artificial intelligence guardrails to generate the optimized chatbot prompt.

13. The system of claim 12, wherein the processor allows a user to adjust one or more attributes of the artificial intelligence guardrail.

14. A machine learning method for artificial intelligence prompt optimization, comprising the steps of:
receiving at a prompt optimization processor an original chatbot prompt from an end-user computing device in communication with the prompt optimization processor;
generating at least one prompt optimization component at the prompt optimization processor;
processing by the prompt optimization processor the original chatbot prompt and the at least one prompt optimization component to generate an optimized chatbot prompt; and
transmitting the optimized chatbot prompt to a chatbot platform in communication with the prompt optimization processor for processing by the chatbot platform.

15. The method of claim 14, wherein the at least one prompt optimization component comprises a first prompt optimization component associated with an end-user behavior and personality.

16. The method of claim 15, further comprising retrieving a pre-defined behavioral profile based on an end-user role and generating the first optimization component based on one or more traits of the behavioral profile.

17. The method of claim 16, further comprising allowing the end-user to adjust the one or more traits of the behavioral profile.

18. The method of claim 15, wherein the at least one prompt optimization component comprises a second prompt optimization component associated with information relating to an industry.

19. The method of claim 18, further comprising analyzing the original chatbot prompt to determine at least one of industry-specific language and context.

20. The method of claim 19, further comprising retrieving industry-specific data from a data source based on the industry-specific language or context.

21. The method of claim 20, further comprising generating the second prompt optimization component using the industry-specific data.

22. The method of claim 18, wherein the at least one prompt optimization component comprises a third prompt optimization component associated with information relating to a company.

23. The method of claim 22, further comprising generating a plurality of variables in response to the information relating to the company and generating the third prompt optimization component based on the plurality of variables.

24. The method of claim 23, further comprising allowing an end-user to adjust one or more of the plurality of variables.

25. The method of claim 14, further comprising generating one or more artificial intelligence guardrails and processes the at least one optimization component and the one or more artificial intelligence guardrails to generate the optimized chatbot prompt.

26. The method of claim 25, further comprising allowing a user to adjust one or more attributes of the artificial intelligence guardrail.
